(19) United States
(12) Patent Application Publication
(10) Pub. No.: US 2023/0139153 A1
(43) Pub. Date: May 4, 2023

(54) Method for the Return of a Small Vehicle at a Base Station by a User of the Small Vehicle

(71) Applicant: Waterman Charging System GmbH, Berlin (DE)

(72) Inventors: Martin Reinhold, Bremen (DE); Helmut Kueckens, Berlin (DE)

(21) Appl. No.: 17/780,551

(22) PCT Filed: Dec. 16, 2020
(86) PCT No.: PCT/EP2020/086593

§ 371 Date: May 27, 2022

(30) Foreign Application Priority Data
Dec. 18, 2019 (DE) 10 2019 135 023.9

(51) Int. Cl. G06Q 30/0645; G06K 7/14

(52) U.S. Cl. CPC G06Q 30/0645; G06K 7/1417

(57) ABSTRACT

Method for returning a small vehicle (3) to a base station (2) by a user of the small vehicle (3), in particular for position detection during the return, comprising the following method steps:

Transfer of the small vehicle (3) by the user into a predetermined distance from the base station (2),

Generation of a scan (9) of a first identifier (11), which is attached to the base station (2), by means of a mobile telephone (8) by the user,

information technology recording and evaluation of the scan (9), information technology blocking of the small vehicle (3) for further use of the small vehicle (3) by the user.

### CROSS REFERENCE TO RELATED APPLICATIONS

This application is the U.S. national stage of International Application No. PCT/EP2020/086593, filed on 2020Dec. 16. The international application claims the priority of DE 102019135023.9 filed on 2019 Dec. 18; all applications are incorporated by reference herein in their entirety.

### BACKGROUND

The invention relates to a method for returning a small vehicle to a base station by a user of the small vehicle.

Currently, so-called rental e-scooters/e-bikes are parked in large numbers in public traffic areas. These are often parked inappropriately, they can be found in trees and bodies of water or are parked in a way that obstructs traffic. It is to be expected that some municipalities will regulate this type of renting much more strictly. In addition, due to improper handling for charging and parking, the average life of such vehicles is sometimes limited to a few months.

However, improperly parked small vehicles also represent a direct source of danger. For example, visually impaired people in particular can easily trip over vehicles lying on the ground.

### SUMMARY

It is therefore the object of the invention to provide an improved possibility for parking small vehicles, in particular in public areas. This is solved by a method according to the main claim; embodiments are the subject of the subclaims and the description.

In particular, a first identifier is to be scanned at the base station as part of the return of the small vehicle. This can ensure that at least the user is located at the base station.

### DETAILED DESCRIPTION

In one embodiment, the identifiers at the base station and at the vehicle are scanned. This must be done within a certain time limit. This ensures that the vehicle is also located at the base station at least at the time of return.

In an embodiment, the vehicle interacts mechanically with the base station. The interaction can take many forms. However, this interaction requires that the first identifier becomes scannable at the base station in the first place. Without corresponding interaction, the first identifier remains hidden and cannot be scanned.

Overall, a suitable base station can be operated without providing power. Thus, such base station can be provided cheaply in large quantities.

Without a scan of the first identifier, in particular, a return is excluded.

The return can be made in particular without mechanical locking. Unauthorized removal/movement can be made more difficult by an alarm mechanism on the vehicle. The alarm mechanism can be triggered as soon as a movement of the vehicle is detected. For example, the movement of the vehicle may be triggered by an accelerometer. Alternatively, the movement of the vehicle can be detected by position detection, in particular using a GPS unit. During a period in which movement of the vehicle is unauthorized, a brake of the vehicle may be activated.

The term small vehicle may be replaced in particular as follows: Vehicle intended for use by exactly one person, and/or two-wheeled vehicle.

### BRIEF DESCRIPTION OF THE DRAWINGS

The invention is explained in more detail below with reference to the figures; herein shows

FIG. 1 a return station arrangement suitable for the claimed method;

FIG. 2 a cell phone with two identifiers of the return station arrangement;

FIG. 3 schematic details of the return station arrangement during a return operation, with the interior of the base station visible;

FIG. 4 schematic details of the return station assembly during the return process, with the interior of the base station obscured.

### DETAILED DESCRIPTION OF THE PREFERRED EMBODIMENTS

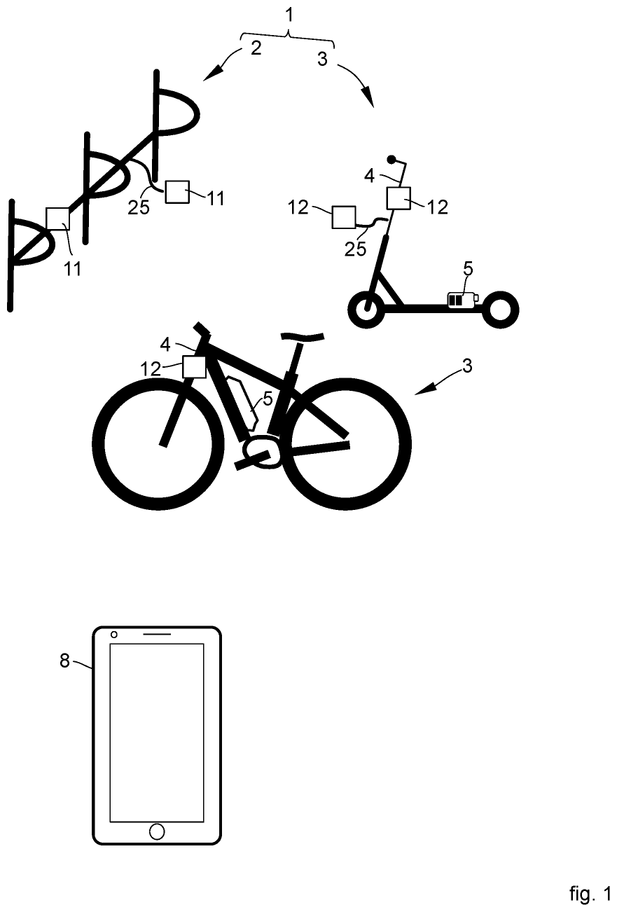

FIG. 1 shows a return station arrangement 1 comprising a base station 2 and a small electric vehicle 3. The small electric vehicle 3 comprises a rechargeable battery 5. The small electric vehicle 3 may be a scooter or a bicycle. However, the invention is also applicable to such small vehicles which are operated without an electric motor and thus without an accumulator. The following description is representative of all such vehicles.

A first machine-readable identifier 11 is attached to the base station 2. Such an identifier can be a QR code.

The small electric vehicle 3 has been rented by a user and is now to be returned to the base station 2. On a cell phone 5 owned by the user an app operated by a rental provider is running. During the return process, the user scans the first identifier 11 at the base station with the cell phone 5. By scanning, the user provides proof that the user is located at the base station location. In the app, the use of the small electric vehicle 3 is linked to the user. Via a data connection, the linked small electric vehicle 3 is now transferred to a locked state in which use of the vehicle is prevented.

In this way, it can be avoided that the small electric vehicle 3 is parked at any place.

In a further embodiment, the security of the location-based return can be increased. For this purpose, a second identifier 12 is arranged on the small electric vehicle 3. During the return process, the user is required to scan both the first identifier 11 and the second identifier 12 through the cell phone 8 within a predefined period of time (e.g., within 5 seconds). Thus, it can be verified that the small electric vehicle 3 itself is located at the location of the base station 2 in addition to the cell phone 8 during the return process.

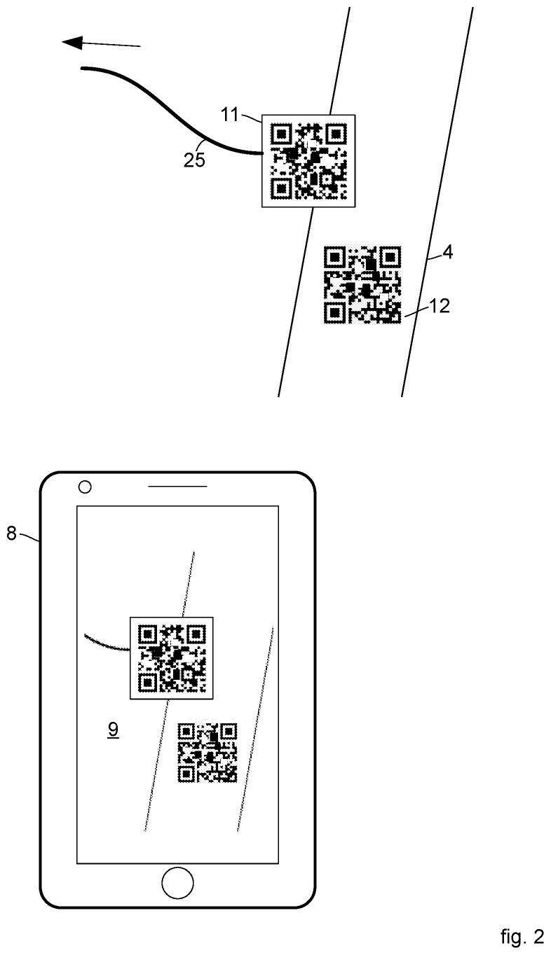

In one embodiment, the two identifiers 11, 12 are each in the form of QR codes and are arranged on the base station or on the small electric vehicle 3 in such a way that both can be scanned by the cell phone 8, in particular simultaneously. It is thus conceivable that a joint scan 9, here in the form of an image, of both identifiers 21, 22 is generated, as FIG. 2 shows. The scan 9 can now be evaluated electronically. In particular, this evaluation provides an assignment between the small electric vehicle and the return location. The evaluation can be fully automatic.

One of the identifiers 11, 12 can be connected to a securing line 25 with the base station 2 or with the small electric vehicle 3. The term securing line is to be understood quite broadly and includes steel cables, chains, a push link belt, a gooseneck, a spring balancer or other devices which enable mobility within a predetermined effective radius of in particular less than 1 m around the base station 2, but at the same time counteract unauthorized removal of the respective identifier from this effective radius. The mobility of at least one of the identifiers 11, 12 makes it easy for the user to position the two identifiers 11, 12 so close to each other that they can be scanned within the specified time limit, in particular simultaneously.

A certain stability of the security line, in particular in the form of a gooseneck, is preferred, as the identifier can maintain a set position at least for a short time. The user could thus have both hands available for scanning the two QR codes.

Purely by way of example, in the present embodiment the second identifier 12 is attached to the handlebar 4 of the small electric vehicle 3 and the first identifier is connected to the base station via the securing line 25. By selecting the length of the securing line 25, it can now be ensured that the small electric vehicle is located within a permissible return space. Alternatively or additionally, the second identifier can also be attached to the small vehicle via a securing line.

In one possible embodiment, the aforementioned procedure is safeguarded by a validation step. This can be used to detect possible manipulation. For example, it would be conceivable for a copy of the identifier to be provided for scanning instead of the identifier. This is because a copy of, for example, an original QR code that has been photographed can easily be displayed at another location via a cell phone.

In the validation step, it is additionally checked whether the first identifier 11 is located at the location of the second identifier 22. For this purpose, an additional method is used to determine the position of the cell phone or the vehicle. This can be done using an electronic position acquisition functionality of the cell phone and/or the vehicle. The position acquisition may be performed using GPS or using networks or mobile cells present in the environment. The position of the first identifier 11 can be stored in a database and queried for the validation step. The position determined in this way is now compared with the stored position. If there is a significant deviation, in particular above a tolerated deviation, an error message can be output and/or the return procedure cannot be completed. A tolerated deviation can be defined depending on the measurement accuracy of the respective position detection functionality used.

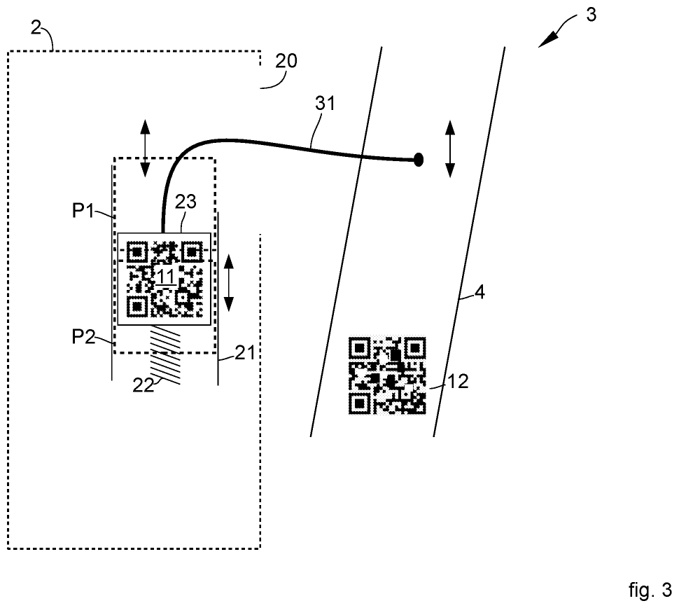

FIG. 3 shows a further embodiment. Here, a mechanism ensures that the first identifier 11 can only be scanned when the small electric vehicle 3 is in mechanical connection with the base station 2.

The first identifier 11 is movably attached to the base station 2 and can be transferred between a first position P1 and a second position P1 in a defined manner by means of a guide 21. A resetter 22 presses the first identifier 11 into the first position P1 as standard. The resetter can be operated by a spring force or by weight force.

A driver 31 is arranged on the small electric vehicle 3, which is inserted in particular into an insertion opening 20 during a return process and interacts there with a counterpart 23 to the driver on the base station 2. The driver 31 is now arranged in such a way that, when the small electric vehicle 3 is lowered, it displaces the first identifier 11 from the first position P1 to the second position P2, counter to the action of the resetter 22.

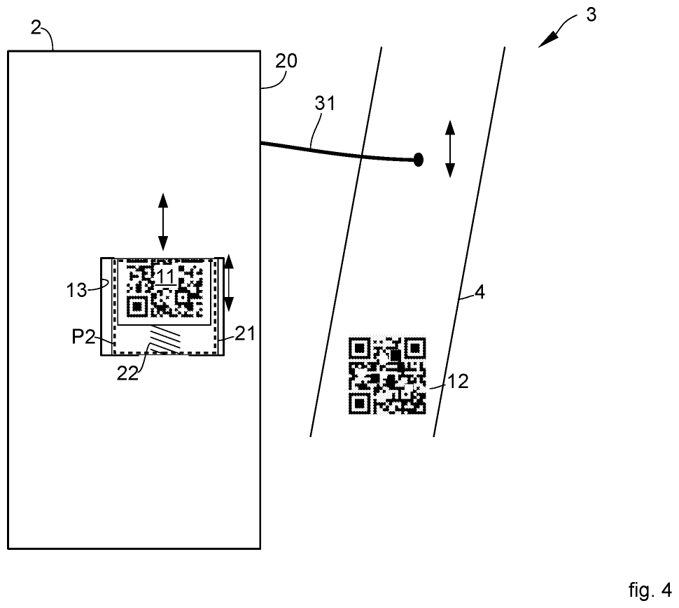

FIG. 4 shows the situation from the outside. A scan window 13 is arranged at the base station 2, which is in overlay with the second position P2 and enables a scan access in to the first identifier 11, if this is in the second position P2.

In this case, the second identifier 12 can be omitted because the first identifier is scannable only when the small electric vehicle 3 is in mechanical operative connection with the base station.

Now the user could trick this mechanism and scan the first identifier 11 at the base station, where another small electric vehicle is already arranged, since this identifier is visible. However, another small electric vehicle is already assigned to this identifier; thus, this first identifier 11 is blocked for further return until this other small electric vehicle has been rented again.

In a variation not explicitly shown, the first identifier is not displaceable between the first and second positions; rather, the first identifier is immovably disposed at the second position P2. Instead, the scan window 13 is displaceable, in particular displaceable or rotatable, between a first position P1 and the second position P2. Accordingly, a cover is provided which can cover the first identifier 11. The term scan window 13 is to be understood broadly and designates a non-concealing, possibly displaceable region, of a cover body. The scan window does not necessarily have to be framed.

The following applies in particular to both of the aforementioned possibilities: Only if both the viewing window 413 and the first identifier 11 are arranged at the second position P2 is the first identifier 11 scannable through the scanning window 13.

### LIST OF REFERENCE NUMERALS

1 return station arrangement
2 base station
3 small electric vehicle
4 steering rod of small electric vehicle
5 battery
8 mobile phone
9 scan of identifier
11 first identifier
12 second identifier
13 scan window
20 insertion opening
21 guide
22 resetter
23 counterpart
31 tappet
P1 first position (concealed)
P2 second position (scannable)
25 securing line

1-12. (canceled)

13. Method for returning a small vehicle (3) to a base station (2), comprising the following method steps:
transfer of the small vehicle (3) into a predetermined distance from the base station (2),
generation of a scan (9) of a first identifier (11), which is attached to the base station (2), by means of a mobile telephone (8),
generation of a scan (9) of a second identifier (12), which is attached to the small vehicle (3), by means of a mobile telephone (8),
wherein the scan (9) of the second identifier (12) and the scan of the first identifier (11) must take place within a time specification, in particular of less than 1 second,
information technology recording and evaluation of the scan (9), information technology blocking of the small vehicle (3) for further use of the small vehicle (3).

14. Method according to claim 13,
characterized by the following method step:
generation by the user of a scan (9) of a second identifier (12), which is attached to the small vehicle (3), by means of the mobile telephone (8), wherein the scan (9) of the second identifier (12) and the scan of the first identifier (11) are performed simultaneously.

15. Method according to claim 13,
characterized in
that the provision of the first identifier (11) does not require energy provision by the base station (2).

16. Method according to claim 13,
characterized in
that the first identifier (11) and/or the second identifier (12) comprises a QR code.

17. Method according to claim 13,
characterized in
that prior to the return, the base station (2) is in a state in which the first identifier (11) is not scannable by the cell phone (8);
in that by mechanical interaction of the small vehicle (3) with the base station (2), the base station is transferred into a second state in which the first identifier (11) is scannable by the cell phone (8).

18. Method according to claim 17,
characterized in
that in the first state the base station (2) covers the first identifier (11) so that the scan of the first identifier by the cell phone (8) is prevented, and in that in the second state the base station (2) exposes the first identifier (11) so that scanning of the first identifier by the mobile telephone (8) is enabled,
in particular in that in the second state a scanning window (13) is in overlap with the first identifier (11), the first identifier (11) being scannable through the scanning window.

19. Method according to claim 18,
characterized in
that, in the first state, the scan window (13) and the first identifier (11) are arranged in respectively different positions (P1, P2),
in that, in the second state, the scan window (13) and the first identifier (11) are arranged in respective mutually corresponding positions (P2).

20. Method according to claim 13,
characterized in,
that the first identifier (11) is blocked in terms of information technology by the return process for the return of a further small vehicle (3),
in particular in that the blocking of the first identifier (11) is removed in terms of information technology as soon as the small vehicle (3) is rented again.

21. Method according to claim 13,
characterized in
that the first identifier (11) is movably connected to the base station by means of a securing line (25) and/or in that the second identifier (12) is movably connected to the small vehicle by means of a securing line (25);
in particular, the securing line (25) ensures that the small vehicle (3) is located at a predetermined distance from the base station during a joint scan of the two identifiers (11, 12).
